(19) United States
(12) Patent Application Publication
(10) Pub. No.: US 2012/0191593 A1
(43) Pub. Date: Jul. 26, 2012

(54) PROVIDING AN INTERFACE TO LOAN INFORMATION

(75) Inventors: Gino A. Lensink, West Hartford, CT (US); Kevin Malvey, Charlotte, NC (US); Kathleen A. Thompson, Hebron, CT (US); Val Scott Roman, Kensington, CT (US); Joseph Barone, Middletown, CT (US); Diane C. Carleton, Dallas, TX (US); Heather L. Holeman, Charlotte, NC (US); Brittany S. Luloff, Boston, MA (US); Suzanne T. Winkler, Sellersburg, IN (US)

(73) Assignee: Bank of America Corporation, Charlotte, NC (US)

(21) Appl. No.: 13/013,958

(22) Filed: Jan. 26, 2011

(51) Int. Cl. G06Q 40/00

(52) U.S. Cl. 705/38

(57) ABSTRACT

In an exemplary embodiment, a method includes receiving a request from a client access module to access loan information from a loan system, wherein the request is initiated by a selected one of a client and a participant. A processor determines whether the request is initiated by the participant and retrieves loan information associated with the request. The retrieved loan information is communicated through the client access module to the participant if the request is initiated by the participant.

### TECHNICAL FIELD OF THE INVENTION

This invention relates generally to loan systems and, more specifically, to providing an interface to loan information.

### BACKGROUND OF THE INVENTION

Entities interact with financial institutions to conduct financial transactions, such as loan servicing. Currently, financial institutions rely on third parties to facilitate the loan servicing process and to facilitate the interaction with the entities associated with the loan. The reliance on third parties, however, results in various complexities and inefficiencies.

### SUMMARY OF THE INVENTION

In accordance with the teachings of the present disclosure, disadvantages and problems associated with providing an interface to loan information may be reduced or eliminated.

According to an exemplary embodiment, a method includes receiving a request from a client access module to access loan information from a loan system, wherein the request is initiated by a selected one of a client and a participant. A processor determines whether the request is initiated by the participant and retrieves loan information associated with the request. The retrieved loan information is communicated through the client access module to the participant if the request is initiated by the participant.

Certain embodiments of the invention may provide one or more technical advantages. A technical advantage of one embodiment includes efficiently retrieving loan information from a loan system for presentation to a user. Another advantage includes using a client access module to facilitate the retrieval of loan information from within an enterprise. Therefore, retrieval process may be handled internally within the enterprise without relying on third party systems external to the enterprise to communicate information between users involved in the loan transaction. Applications and systems within the enterprise may be leveraged to efficiently handle the requests for loan information and to further streamline the retrieval process. Yet another technical advantage includes providing the functionality on-line rather than using manual processes to retrieve and provide the information to the user.

Certain embodiments of the present disclosure may include none, some, or all of the above technical advantages. One or more other technical advantages may be readily apparent to one skilled in the art in view of the figures, descriptions, and claims of the present disclosure.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating an example embodiment of a system for providing an interface to loan information;

FIG. 2 is a block diagram illustrating an example embodiment of an interface application module; and

FIG. 3 is a flow chart illustrating an example method for providing a user interface to loan information.

### DETAILED DESCRIPTION OF THE INVENTION

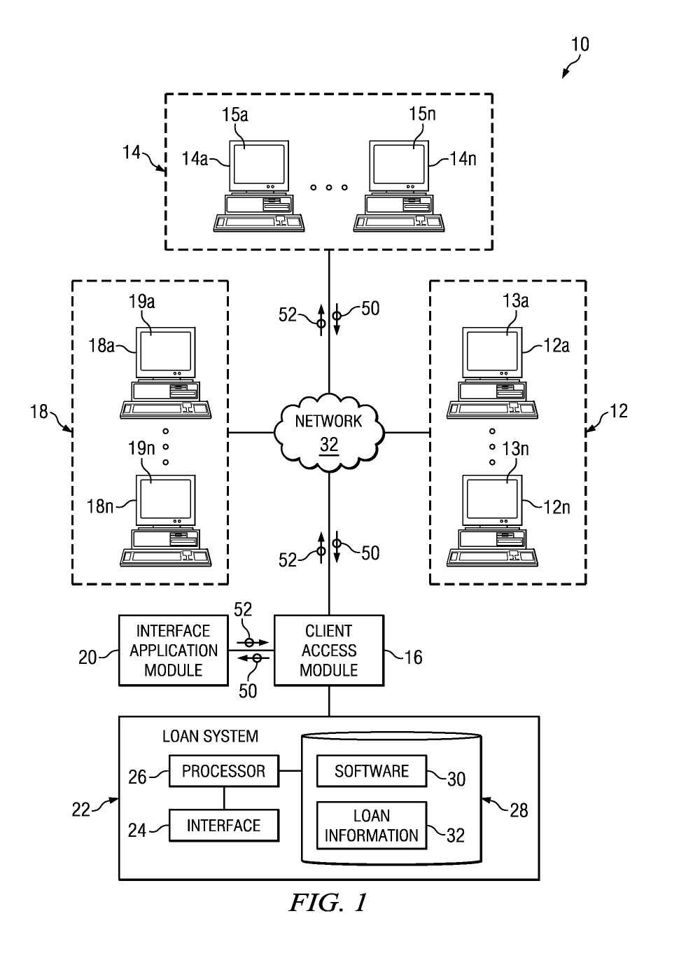

Embodiments of the present invention and its advantages are best understood by referring to FIGS. 1 through 3, wherein like numerals refer to like and corresponding parts of the various drawings.

FIG. 1 is a block diagram illustrating an example embodiment of a system 10 for providing a user interface to loan information. System 10 includes a Client Access Module (CAM) 16 that communicates information from loan system 22 to clients 12 and participants 14 over network 32 using interface application module (IAM) 20. IAM 20 processes requests received from clients 12 and participants 14 and facilitates the presentation of loan information to clients 12 and participants 14.

Business enterprises have increasingly relied on the world wide web to communicate information with various entities. For example, the world wide web has been used to enable business applications and conduct business transactions. Even though financial institutions have started using the world wide web to provide banking solutions for entities that participate in banking transactions, the use of the world wide web in the context of loan management has been a manual process that involves third parties in addition to the enterprise and the participating entity. Conventional techniques for providing loan information to a participant entity include communicating information via third party components, which usually involves manual work by the enterprise that manages the loan transaction. The teachings of the present disclosure recognize that it would be desirable to provide an interface to loan information to minimize and/or avoid problems associated with conventional techniques for managing loans.

Client 12 represents any suitable combination of hardware, software, and controlling logic capable of communicating with CAM 16 over network 32. Client 12 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10. A user of client 12 may interact with one or more web pages hosted by CAM 16. Additionally or in the alternative, a user of client 12 may communicate with IAM 20 and loan system 22 by interacting with CAM 16. Client 12 may represent any number of clients and/or users. In some embodiments, client 12 may represent a user that has received proceeds from an enterprise in the form of a loan. Client 12 may also comprise a user interface, such as a display, a microphone, keypad, or other appropriate terminal equipment usable by a user. In the illustrated embodiment, client 12 includes a graphical user interface (GUI) 13.

GUI 13 represents any suitable graphical arrangement of information presented to the user and/or entered by a user of client 12. For example, GUI 13 may display information received from a website and/or CAM 16. GUI 13 is generally operable to tailor and filter data entered by and presented to the user. In some embodiments, GUI 13 may be displayed by a web browser associated with client 12. GUI 13 may provide the user with an efficient and user-friendly presentation of information. GUI 13 may comprise a plurality of displays having interactive fields, pull-down lists, and buttons operated by the user. GUI 13 may include multiple levels of abstraction including groupings and boundaries. It should be understood that the term GUI 13 may be used in the singular or in the plural to describe one or more GUIs 13 in each of the displays of a particular client 12.

Participant 14 represents any suitable combination of hardware, software, and controlling logic capable of communicating with CAM 16 over network 32. Participant 14 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10. A user of participant 14 may interact with one or more web pages hosted by CAM 16. Additionally or in the alternative, a user of participant 14 may communicate with IAM 20 and loan system 22 by interacting with CAM 16. By communicating with IAM 20 and loan system 22, participant 14 may receive loan information, such as notifications of transactions involving loans of interest, borrowing base documentation, ineligibles, accounts receivable aging spreads, concentrations, letters of credit, interest statements and notices, loan balances, fees, settlement statements, reporting information, financial statements, legal documents, collateral information, and/or company/industry information. Participant 14 may also make online submissions for borrowing base certificates, advance requests, London Interbank Offered Rate notifications, file submissions, and/or customer service requests.

Participant 14 may represent any number of entities and/or users. In some embodiments, participant 14 may represent an entity that purchases one or more loans from which a user of client 12 has received the proceeds. Participant 14 may also comprise a user interface, such as a display, a microphone, keypad, or other appropriate terminal equipment usable by a user. In the illustrated embodiment, participant 14 includes a GUI 15. Users of participant 14 may view the loan information on GUI 15 and/or may submit online service requests regarding a loan on GUI 15.

GUI 15 represents any suitable graphical arrangement of information presented to the user and/or entered by a user of participant 14. For example, GUI 15 may display information received from a website and/or CAM 16. GUI 15 is generally operable to tailor and filter data entered by and presented to the user. In some embodiments, GUI 15 may be displayed by a web browser associated with participant 14. GUI 15 may provide the user with an efficient and user-friendly presentation of information. GUI 15 may comprise a plurality of displays having interactive fields, pull-down lists, and buttons operated by the user. GUI 15 may include multiple levels of abstraction including groupings and boundaries. It should be understood that the term GUI 15 may be used in the singular or in the plural to describe one or more GUIs 15 in each of the displays of a particular participant 14. An example of GUI 15 that is generally operable to interact with CAM 16 and/or present information to a user of participant 14 is presented in FIG. 3, which is described in greater detail below.

Administrator 18 represents any suitable combination of hardware, software, and controlling logic capable of communicating with CAM 16 over network 32 to manage the communication between clients 12, participants 13, CAM 16, IAM 20, and loan system 22. Administrator 18 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10. A user of administrator 18 may interact with one or more web pages hosted by CAM 16. Additionally or in the alternative, a user of administrator 18 may communicate with IAM 20 and loan system 22 by interacting with CAM 16. By communicating with IAM 20 and loan system 22, administrator 18 may initiate transactions with client 12 and/or participant 14, post information for client 12 or participant 14 to access, delete information associated with a loan, and/or manage entitlements and notification preferences of client 12 and participant 14. Administrator 18 may represent any number of entities and/or users. In some embodiments, administrator 18 may represent an associate of an enterprise that acts as the agent between client 12 and participant 14. In this embodiment, administrator 18 may determine what type of information CAM 16 communicates to client 12 or participant 14. For example, IAM 20 collects information associated with a request and administrator 18 determines what information of the collected information client 12 or participant 14 may access. Administrator 18 may determine that a subset of the collected information is displayed to client 12 or participant 14. Alternatively, administrator 18 may determine that client 12 or participant 14 may access all of the collected information. Administrator 18 may also comprise a user interface, such as a display, a microphone, keypad, or other appropriate terminal equipment usable by a user. In the illustrated embodiment, administrator 18 includes a GUI 19. Users of administrator 18 may view information on GUI 19 and/or may manage online service requests regarding loan information on GUI 19.

GUI 19 represents any suitable graphical arrangement of information presented to the user and/or entered by a user of administrator 18. For example, GUI 19 may display information received from a website and/or CAM 16. GUI 19 is generally operable to tailor and filter data entered by and presented to the user. In some embodiments, GUI 19 may be displayed by a web browser associated with administrator 18. GUI 19 may provide the user with an efficient and user-friendly presentation of information. GUI 19 may comprise a plurality of displays having interactive fields, pull-down lists, and buttons operated by the user. GUI 19 may include multiple levels of abstraction including groupings and boundaries. It should be understood that the term GUI 19 may be used in the singular or in the plural to describe one or more GUIs 19 in each of the displays of a particular administrator 18.

CAM 16 represents any suitable combination of hardware, software, and controlling logic operable to communicate information from IAM 20 and loan system 22 to client 12 and/or participant 14 over network 32. Using IAM 20, CAM 16 may facilitate the presentation of information from loan system 22 to client 12 on GUI 13 and/or participant 14 on GUI 15. CAM 16 may receive requests from client 12 and/or participant 14 to retrieve loan information. In an embodiment, CAM 16 represents a web portal for communicating with client 12 and/or participant 14 that includes a website for displaying information. In some embodiments, CAM 16 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of CAM 16 may be performed by any suitable combination of one or more servers or other components at one or more locations. In the embodiment where the module is a server, the server may be a private server, and the server may be a virtual or physical server. The server may include one or more servers at the same or remote locations. Also, CAM 16 may include any suitable component that functions as a server.

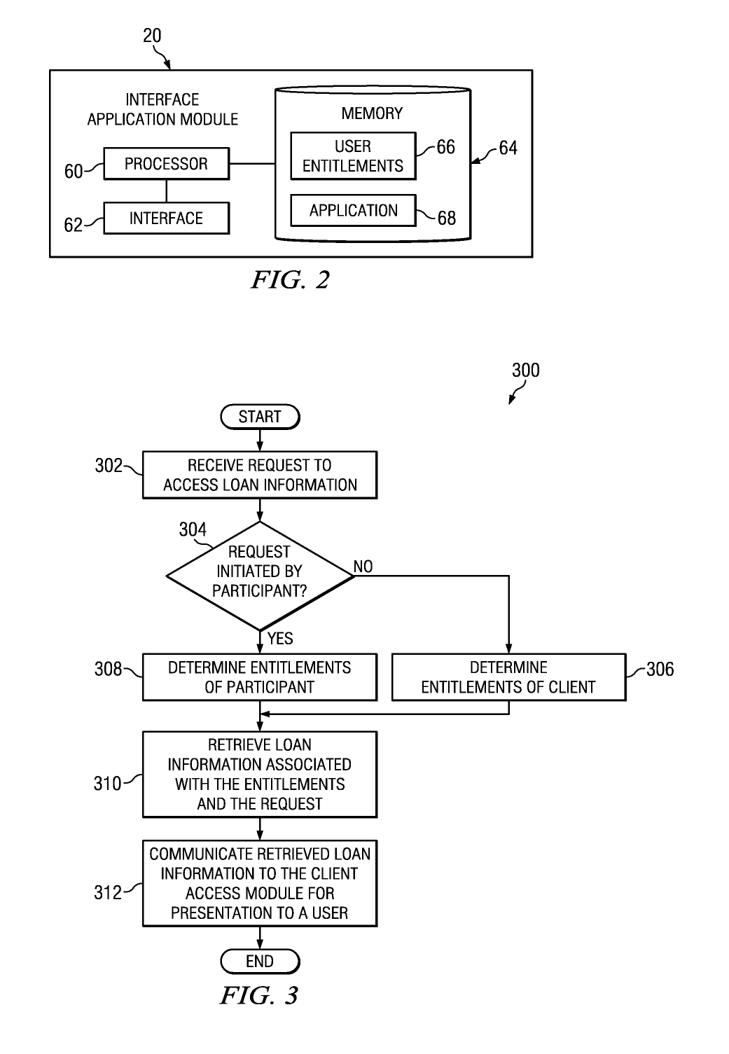

IAM 20 represents any combination of hardware, software, and controlling logic to facilitate the interaction between clients 12, participants 14, and loan system 22. For example, IAM 20 determines whether a user of participant 14 is entitled to access certain loan information stored by loan system 22. IAM 20 may also facilitate retrieval of the loan information if participant 14 is entitled to access the loan information. IAM 20 may include a network server, any suitable remote server, a mainframe, a host computer, a workstation, a web server, a personal computer, a file server, or any other suitable device operable to communicate with the other components of system 10. In some embodiments, IAM 20 may execute any suitable operating system such as IBM's z/OS, MS-DOS, PC-DOS, MAC-OS, WINDOWS, UNIX, OpenVMS, or any other appropriate operating system, including future operating systems. The functions of IAM 20 may be performed by any suitable combination of one or more servers or other components at one or more locations. In the embodiment where the module is a server, the server may be a private server, and the server may be a virtual or physical server. The server may include one or more servers at the same or remote locations. Also IAM 20 may include any suitable component that functions as a server. Details of an exemplary embodiment of IAM 20 are discussed in more detail with respect to FIG. 2 below.

Loan system 22 represents any combination of hardware, software, and controlling logic to maintain financial information and/or communicate financial information to IAM 20 and/or CAM 16. For example, loan system 22 may maintain information associated with one or more loan accounts of a user associated with client 12. As another example, loan system 22 may maintain information associated with a plurality of loans purchased by a user associated with participant 14. Loan system 22 may also represent a collateral tracking system and/or an accounts receivable/ineligibles system. Loan system 22 may include a network server, any suitable remote server, a mainframe, a host computer, a workstation, a web server, a personal computer, a file server, or any other suitable device operable to communicate with the other components of system 10. In some embodiments, loan system 22 may execute any suitable operating system such as IBM's z/OS, MS-DOS, PC-DOS, MAC-OS, WINDOWS, UNIX, OpenVMS, or any other appropriate operating system, including future operating systems. The functions of loan system 22 may be performed by any suitable combination of one or more servers or other components at one or more locations. In the embodiment where the module is a server, the server may be a private server, and the server may be a virtual or physical server. The server may include one or more servers at the same or remote locations. Also loan system 22 may include any suitable component that functions as a server. In the illustrated embodiment, loan system 22 comprises a processor 24, an interface 26, and memory 28.

Interface 24 represents a device operable to receive information from CAM 16, transmit information through CAM 16, perform processing of information, communicate to other devices, or any combination of the preceding. For example, interface 24 receives requests for loan information 30 from IAM 20. Interface 24 represents any port or connection, real or virtual, including any suitable hardware and/or software, including protocol conversion and data processing capabilities, to communicate through a LAN, WAN, or other communication system that allows loan system 22 to exchange information with clients 12, participants 14, CAM 16, IAM 20, or other components of system 10.

Processor 26 communicatively couples to interface 24 and memory 28 and controls the operation and administration of loan system 22 by processing information received from interface 24 and memory 28. Processor 26 includes any hardware and/or software that operates to control and process information. For example, processor 26 executes software 30 to control the operation of loan system 22. Processor 26 may be a programmable logic device, a microcontroller, a microprocessor, any suitable processing device, or any suitable combination of the preceding.

Memory 28 stores, either permanently or temporarily, data, operational software, or other information for processor 26. Memory 28 includes any one or a combination of volatile or non-volatile local or remote devices suitable for storing information. For example, memory 28 may include random access memory (RAM), read only memory (ROM), magnetic storage devices, optical storage devices, or any other suitable information storage device or a combination of these devices. While illustrated as including particular modules, memory 28 may include any suitable information for use in the operation of loan system 22.

In the illustrated embodiment, memory 28 includes software 30 and loan information 32. Software 30 represents any suitable set of instructions, logic, or code embodied in a computer-readable storage medium and operable to facilitate the operation of loan system 22. Loan information 32 represents any information regarding loan accounts handled by an enterprise. For example, loan information 32 includes account numbers, identifiers associated with an account, balance information of an account, disclaimers associated with an account, notifications of transactions involving loans of interest, reporting information, financial statements, legal documents, collateral information, company/industry information, any other suitable data, or any combination of the preceding.

Network 32 represents any network operable to facilitate communication between the components of system 10 such as clients 12, participants 14, CAM 16, IAM 20, and/or loan system 24. Network 32 may include any interconnecting system capable of transmitting audio, video, signals, data, messages, or any combination of the preceding. Network 32 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

In an exemplary embodiment of operation, CAM 16 facilitates communication between clients 12, participants 14, IAM 20 and loan system 22 to provide certain loan information 32 to users. CAM 16 may receive a request 50 from participant 14a to retrieve loan information 32. CAM 16 communicates request 50 to IAM 20 for processing. From the information in request 50, IAM 20 determines the type of user and determines what loan information 32 to retrieve based on the type of user. In an embodiment, IAM 20 determines the entitlements of a user, which impacts the type of loan information 32 retrieved from loan system 22. For example, participant 14a may have rights to a subset of loan information 32 on a plurality of loans, and IAM 20 will retrieve the subset of loan information 32 to provide to participant 14a. IAM 20 communicates with loan system 22 to retrieve the appropriate loan information 32. Upon retrieving loan information 32, IAM 20 communicates response 52 to CAM 16. In an embodiment, response 52 includes loan information 32 based on the type of the user and the entitlements of the user. CAM 16 communicates response 52 to participant 14a. In particular embodiments, CAM 16 presents response 52 to participant 14a in a form on GUI 15a.

A component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic. Any suitable logic may perform the functions of system 10 and the components within system 10.

Modifications, additions, or omissions may be made to system 10 without departing from the scope of the invention. For example, CAM 16 may communicate with any number and combination of IAMs 20 and loan systems 22 to provide loan information to clients 12 and/or participants 14. Furthermore, an enterprise may represent any number and/or combinations of suitable financial centers that may be located in geographically diverse locations.

FIG. 2 is a block diagram illustrating an example embodiment of IAM 20. IAM 20 communicates with CAM 16 and loan system 22 to provide loan information 32 to clients 12 and/or participants 14. As illustrated, CAM 16 includes a processor 60, interface 62, and memory 64.

Processor 60 communicatively couples to interface 62 and memory 64, and controls the operation and administration of IAM 20 by processing information received from interface 62 and memory 64. Processor 60 includes any hardware and/or software that operates to control and process information. For example, processor 60 may process information from user entitlements 66 and application 68 to implement the operation of IAM 20. Processor 60 may be a programmable logic device, a microcontroller, a microprocessor, any suitable processing device, or any suitable combination of the preceding.

Interface 62 represents any suitable device operable to receive information from network 32, transmit information through network 32, perform processing of information, communicate to other devices, or any combination of the preceding. For example, interface 32 receives information from CAM 16 and/or loan system 22. Interface 62 represents any port or connection, real or virtual, including any suitable hardware and/or software, including protocol conversion and data processing capabilities, to communicate through a LAN, WAN, SAN, and/or other communication system that allows IAM 20 to exchange information with network 32, CAM 16, loan system 22, or other components of system 10.

Memory 64 stores, either permanently or temporarily, data, operational software, or other information for use by processor 60. Memory 64 includes any one or a combination of volatile or non-volatile local or remote devices suitable for storing information. For example, memory 64 may include RAM, ROM, magnetic storage devices, optical storage devices, or any other suitable information storage device or a combination of these devices. Memory 64 may include any suitable information for use in the operation of IAM 20. In the illustrated embodiment, memory 64 includes user entitlements 66 and application 68.

User entitlements 66 and application 68 represent logic, rules, algorithms, code, queries, tables, and/or other suitable instructions to facilitate the functions and operations of IAM 20. User entitlements 66 represent settings associated with each user of clients 12 and participants 14. For example, user entitlements 66 may include a user's login credentials or a user's privileges to access particular loan information 32. Application 68 facilitates the retrieval of loan information 32 from loan system 22 in response to a request from a client 12 and/or participant 14.

In an exemplary embodiment of operation, IAM 20 processes requests from clients 12 and/or participants 14 as received from CAM 16. Upon receiving a request, application 68 accesses user entitlements 66 to determine the particular loan information 32 to retrieve from loan system 22. Application 68 accesses user entitlements 66 associated with the request. For example, the request may include an identifier that allows application 68 to determine the appropriate user entitlements 66. In a particular embodiment, application 68 determines that the request is from a user of participant 14 and that the user is entitled to view loan information associated with a group of loans that the user has purchased. Upon determining the type of user and what information the user may view, application 68 facilitates the retrieval of the particular information from loan system 22. Once the information is retrieved, IAM 20 communicates loan information 32 to CAM 16 for presentation to the user in response to the request.

A component of IAM 20 may include an interface, logic, memory, and/or other suitable element. An interface receives input, sends output, processes the input and/or output, and/or performs other suitable operation. An interface may comprise hardware and/or software. Logic performs the operation of the component, for example, logic executes instructions to generate output from input. Logic may include hardware, software, and/or other logic. Logic may be encoded in one or more tangible media, such as a computer readable medium or any other suitable tangible medium, and may perform operations when executed by a computer. Certain logic, such as a processor, may manage the operation of a component. Examples of a processor include one or more computers, one or more microprocessors, one or more applications, and/or other logic. Modifications, additions, or omissions may be made to IAM 20 without departing from the scope of the invention.

FIG. 3 is a flow chart illustrating an example method for providing a user interface to loan information. Method 300 begins at step 302 where a request to access loan information is received. Client 12 or participant 14 communicates the request to CAM 16, and CAM 16 communicates the request to IAM 20 for processing. At step 304, IAM 20 determines whether the request is initiated by client 12 or participant 14. The request may include identification information to allow for IAM 20 to make the determination. In a particular embodiment, application 68 accesses a data record in user entitlements 66 to determine the type of user that initiates the request.

If the request is initiated by client 12, IAM 20 determines the entitlements associated with client 12 at step 306. If the request is initiated by participant 14, IAM 20 determines the entitlements associated with participant 14 at step 308. In an embodiment, application 68 may determine the entitlement information for client 12 or participant 14 by accessing the data record associated with the user in user entitlements 66.

Upon determining the user type and the entitlements of the user, IAM 20 retrieves loan information 32 associated with the entitlements and the request at step 310. IAM 20 communicates with loan system 22 to retrieve loan information 32. At step 412, IAM 20 communicates the retrieved loan information to CAM 16 for presentation to the user.

Modifications, additions, or omissions may be made to method 300 illustrated in the flowchart of FIG. 3. For example, method 300 may process several requests for loan information at once and/or in parallel. As another example, method 300 may include providing notifications to participant 14. The notifications may be based on a transaction initiated by client 12, an update to the loan information by administrator 18, or any other change to the loan information. IAM 20 may communicate the notification to the appropriate participant 14 to inform participant 14 of the transaction and any associated details related to the transaction. In some embodiments, the notification may require participant 14 to take additional action. Additionally, the steps of FIG. 3 may be performed in parallel or in any suitable order.

According to the teachings of the present disclosure, one or more technical advantages may be realized. A technical advantage of one embodiment includes efficiently retrieving loan information from a loan system for presentation to a user. Another advantage includes using a client access module to facilitate the retrieval of loan information from within an enterprise. Therefore, retrieval process may be handled internally within the enterprise without relying on third party systems external to the enterprise to communicate information between users involved in the loan transaction. Applications and systems within the enterprise may be leveraged to efficiently handle the requests for loan information and to further streamline the retrieval process. Yet another technical advantage includes providing the functionality on-line rather than using manual processes to retrieve and provide the information to the user.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. An apparatus, comprising:
an interface operable to:
receive a request from a client access module to access loan information from a loan system, wherein the request is initiated by a selected one of a client and a participant;
a processor operable to:
determine whether the request is initiated by the participant;
retrieve loan information associated with the request;
the interface is further operable to communicate the retrieved loan information through the client access module to the participant if the request is initiated by the participant.

2. The apparatus of claim 1, wherein the request comprises a user identifier; and
the processor is further operable to:
determine whether the request is initiated by the participant comprises accessing a data record associated with the user identifier to determine a user type associated with the user identifier and to determine entitlements associated with the user identifier;
retrieve loan information associated with the request comprises retrieving loan information according to the determined user type and the determined entitlements.

3. The apparatus of claim 1, wherein:
the processor is further operable to determine whether the client has conducted a transaction that affects the loan information;
the interface is further operable to communicate a notification through the client access module to the participant, wherein the notification includes the loan information affected by the transaction.

4. The apparatus of claim 1, wherein:
the processor is further operable to determine whether an administrator has conducted a transaction that affects the loan information;
the interface is further operable to communicate a notification through the client access module to the participant, wherein the notification includes the loan information affected by the transaction.

5. The apparatus of claim 1, wherein the interface is operable to communicate at least one of the following associated with a loan: financial statements, legal documents, collateral information.

6. The apparatus of claim 1, wherein the interface is operable to present the loan information to a user through a graphical user interface.

7. A method, comprising:
receiving a request from a client access module to access loan information from a loan system, wherein the request is initiated by a selected one of a client and a participant;
determining, by a processor, whether the request is initiated by the participant;
retrieving loan information associated with the request;
communicating the retrieved loan information through the client access module to the participant if the request is initiated by the participant.

8. The method of claim 7, wherein:
the request comprises a user identifier;
determining whether the request is initiated by the participant comprises accessing a data record associated with the user identifier to determine a user type associated with the user identifier and to determine entitlements associated with the user identifier;
retrieving loan information associated with the request comprises retrieving loan information according to the determined user type and the determined entitlements.

9. The method of claim 7, further comprising:
determining whether the client has conducted a transaction that affects the loan information;
communicating a notification through the client access module to the participant, wherein the notification includes the loan information affected by the transaction.

10. The method of claim 7, further comprising:
determining whether an administrator has conducted a transaction that affects the loan information;
communicating a notification through the client access module to the participant, wherein the notification includes the loan information affected by the transaction.

11. The method of claim 7, wherein communicating the loan information through the client access module comprises communicating at least one of the following associated with a loan: financial statements, legal documents, collateral information.

12. The method of claim 7, wherein communicating the loan information through the client access module comprises presenting the loan information to a user through a graphical user interface.

13. A non-transitory computer readable medium comprising logic, the logic, when executed by a processor, operable to:
receive a request from a client access module to access loan information from a loan system, wherein the request is initiated by a selected one of a client and a participant;
determine, by a processor, whether the request is initiated by the participant;
retrieve loan information associated with the request;
communicate the retrieved loan information through the client access module to the participant if the request is initiated by the participant.

14. The computer readable medium of claim 13, wherein:
the request comprises a user identifier;
determining whether the request is initiated by the participant comprises accessing a data record associated with the user identifier to determine a user type associated with the user identifier and to determine entitlements associated with the user identifier;
retrieving loan information associated with the request comprises retrieving loan information according to the determined user type and the determined entitlements.

15. The computer readable medium of claim 13, the logic further operable to:
determine whether the client has conducted a transaction that affects the loan information;
communicate a notification through the client access module to the participant, wherein the notification includes the loan information affected by the transaction.

16. The computer readable medium of claim 13, the logic further operable to:
determine whether an administrator has conducted a transaction that affects the loan information;
communicate a notification through the client access module to the participant, wherein the notification includes the loan information affected by the transaction.

17. The computer readable medium of claim 13, wherein communicating the loan information through the client access module comprises communicating at least one of the following associated with a loan: financial statements, legal documents, collateral information.

18. The computer readable medium of claim 13, wherein communicating the loan information through the client access module comprises presenting the loan information to a user through a graphical user interface.
